(19) United States
(12) Patent Application Publication
(10) Pub. No.: US 2024/0412215 A1
(43) Pub. Date: Dec. 12, 2024

(54) DECENTRALIZED AND ANONYMIZED VERIFICATION OF USER CHARACTERISTICS

(71) Applicant: American Express Travel Related Services Company, Inc., New York, NY (US)

(72) Inventor: Andras L. Ferenczi, Scottsdale, AZ (US)

(21) Appl. No.: 18/329,780

(22) Filed: Jun. 6, 2023

(51) Int. Cl. G06Q 20/40

(52) U.S. Cl. CPC G06Q 20/4014

(57) ABSTRACT

Disclosed are approaches for verifying user characteristics in a decentralized and anonymized fashion. A first request is received from a client device to verify a characteristic of a user associated with the client device, the request identifying an attribute service and the request comprising personally identifying information (PII) associated with the user. Then, a second request for one or more attributes of the user is sent to the attribute service, wherein the second request comprises at least a portion of the PII associated with the user of the client device. One or more attributes of the user from the attribute service and anonymized. The anonymized attributes and a prompt are then sent to a verifier service, wherein the prompt causes a large language model associated with the verifier service to verify the characteristic of the user based at least in part on the one or more anonymized attributes.

### BACKGROUND

Users often are required to verify characteristics about themselves when requesting services. For example, a user may need to verify characteristics about their identity or their financial credit worthiness when requesting services from an organization. This may be required in order to prevent fraud or to minimize credit risk to the organization. Accordingly, a user may be required to provide significant amounts of personally identifiable or identifying information to third parties, who the user may or may not trust, in order for the user to verify the relevant characteristics about themselves.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a sequence diagram illustrating one example of interactions between the various components of the network environment of FIG. 1 according to various embodiments of the present disclosure.

FIG. 3 is a sequence diagram illustrating one example of interactions between the various components of the network environment of FIG. 1 according to various embodiments of the present disclosure.

### DETAILED DESCRIPTION

Disclosed are various approaches for verifying user characteristics in a decentralized and anonymized manner. Verifying aspects of a user, such as their credit risk or credit worthiness, their identity, etc. often requires the disclosure of personally identifiable information to third parties. For example, to lease an apartment, open a bank account, open a credit card account, make a large purchase or obtain credit for a large purchase (e.g., a car, a house, a boat, etc.) a user might be required to provide personally identifiable information such as their name, date of birth, government identification (e.g., driver's license number, social security number, etc.), current residential address, current place of employment, etc., in order for the counterparty to perform a credit check and/or verify the identity of the user.

These disclosures personally identifiable information suffer from a number of technical problems. First, the personally identifiable information could be stored by the counterparty indefinitely, creating security risks for the user if the counterparty were to ever lose control of the user's personally identifiable information. Second, the counterparty does not necessarily need to collect or store the personally identifiable information of the user. For example, a landlord may only need to know if the user has the ability to pay the rent for an apartment. The landlord does not necessarily need to know all of the personally identifiable information of the user. As another example, a financial institution may need to verify that the user is who they say the are, and that the user is an appropriate credit risk for opening a line of credit, obtaining a mortgage or car loan, or opening a credit card account. However, the financial institution does not necessarily need all of the user's personally identifiable information. Accordingly, various embodiments of the present disclosure make use of a combination of machine learning models and blockchain technologies to provide verification of user characteristics (e.g., their demographic information, their credit risk or credit worthiness, financial history, etc.) in a manner that does not disclose a user's personally identifiable information to counterparties.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

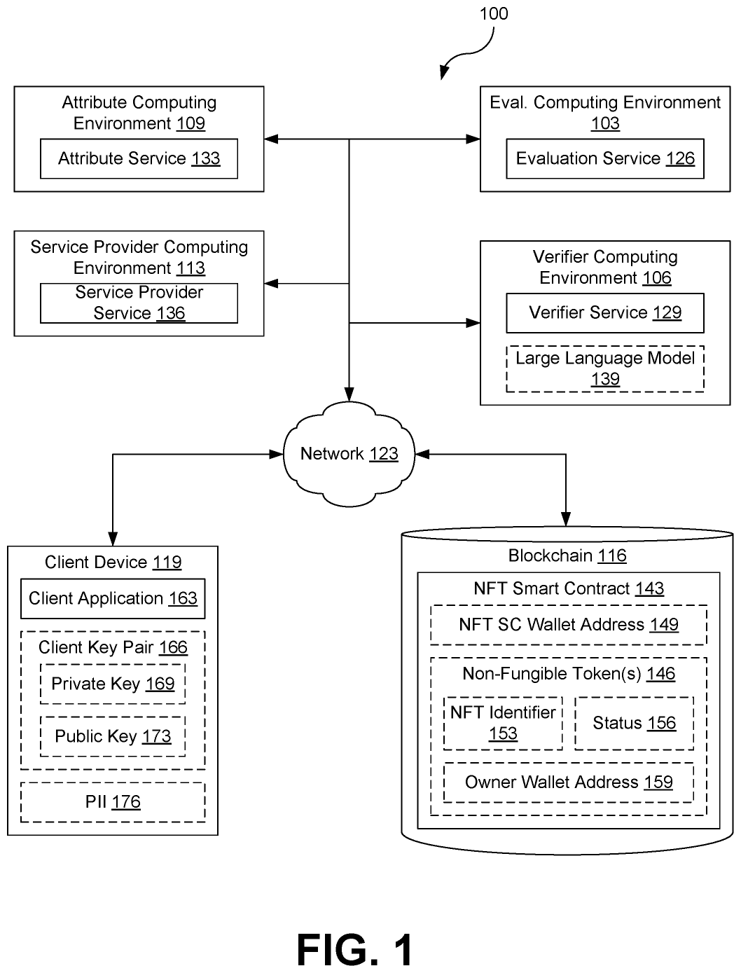

FIG. 1 depicts a network environment 100 according to various embodiments. The network environment 100 can include an evaluation computing environment 103, a verifier computing environment 106, an attribute computing environment 109, a service provider computing environment 113, a blockchain 116, and a client device 119, which can be in data communication with each other via a network 123. Although depicted separately for purposes of clarity, one or more of the evaluation computing environment 103, a verifier computing environment 106, an attribute computing environment 109, and/or a service provider computing environment 113 could be implemented as a single computing environment. This could occur in situations where multiple parties are tenants of the same shared hosting or cloud computing environment. This could occur, for example, where multiple parties host some or all of their information technology or application infrastructure with a cloud computing provider, such as AMAZON WEB SERVICES, MICROSOFT AZURE, GOOGLE CLOUD COMPUTE, etc.

The network 123 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 123 can also include a combination of two or more networks 123. Examples of networks 123 can include the Internet, intranets, extranets, virtual private networks (VPNs), and similar networks.

The evaluation computing environment 103, a verifier computing environment 106, an attribute computing environment 109, and/or a service provider computing environment 113 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the evaluation computing environment 103, the verifier computing environment 106, the attribute computing environment 109, and/or the service provider computing environment 113 can employ a plurality of computing devices that can be arranged in one or more server banks or computer banks or other arrangements. Such computing devices can be located in a single installation or can be distributed among many different geographical locations. For example, the evaluation computing environment 103, the verifier computing environment 106, the attribute computing environment 109, and/or the service provider computing environment 113 can include a plurality of computing devices that together can include a hosted computing resource, a grid computing resource or any other distributed computing arrangement. In some cases, the evaluation computing environment 103, the verifier computing environment 106, the attribute computing environment 109, and/or the service provider computing environment 113 can correspond to an elastic computing resource where the allotted capacity of processing, network, storage, or other computing-related resources can vary over time.

Various applications or other functionality can be executed in the evaluation computing environment 103, the verifier computing environment 106, the attribute computing environment 109, and/or the service provider computing environment 113. The components executed by the evaluation computing environment 103, the verifier computing environment 106, the attribute computing environment 109, and/or the service provider computing environment 113 include an evaluation service 126, a verifier service 129, an attribute service 133, a service provider service 136 and other applications, services, processes, systems, engines, or functionality not discussed in detail herein.

The evaluation service 126 can be executed to evaluate a request to assess a characteristic of a user associated with the client device 119. For example, the evaluation service 126 could receive a request to evaluate a characteristic of a user (e.g., his or her creditworthiness, his or her identity, etc.). The evaluation service 126 could then retrieve one or more attributes (e.g., credit report, financial history, identity information, etc.) from the attribute service 133 and anonymize them. The evaluation service 126 could then provide the attributes to the verifier service 129 along with a prompt or request for the verifier service 129 to verify the characteristic of the user based at least in part on the attributes. In some implementations, the evaluation service 126 or portions of the evaluation service 126 could be executed by a trusted execution environment (TEE) or other secure area or secure enclave provided by a processor of the computing device that is executing or hosting the evaluation service 126.

The verifier service 129 can be executed to verify one or more characteristics of the user associated with the client device 119 based at least in part on one or more attributes provided by the attribute service to the evaluation service 126. In some implementations, the verifier service 129 could act as a front-end for a large language model 139.

The large language model 139 can represent any language model that includes a neural network with many parameters (tens of thousands, millions, or sometimes even billions or more) that is trained on large quantities of unlabeled text using self-supervised learning or semi-supervised learning techniques. Some large language models 139 may be generative—that is they can generate new data based on patterns and structure learned from their input training data. Examples of large language models include various versions of OPENAI's Generative Pre-trained Transformer (GPT) model (e.g., GPT-1, GPT-2, GPT-3, GPT-4, etc.) META's Large Language Model Meta AI (LLaMA), and GOOGLE's Pathways Language Model 2 (PaLM 2), among others. A large language model 139 can be configured to return a response to a prompt, which can be in a structured form (e.g., a request or query with a predefined schema and/or parameters) or in an unstructured form (e.g., free form or unstructured text). For example, a prompt could be a query such as “What is the creditworthiness of an individual with the included credit report?” or “What is the creditworthiness of an individual with the included financial information?”

The attribute service 133 can be executed to return information about attributes related to a user associated with the client device 119. The attribute service 133 could, for example, return user specific attributes in response to a request from the evaluation service 126 that includes personally identifying information of a user of the client device 119. An example of an attribute service 133 could be a credit reporting service provided by a credit bureau that returns credit reports or historical financial data in response to a request. Another example of an attribute service 133 could be a data broker service that provides information about individuals in response to a request, such as biographic, demographic, professional, financial, or similar information of about user.

The service provider service 136 can be executed to provide one or more services to or perform one or more services on behalf of a user of the client device 119. One example of a service provider service 136 could be an electronic commerce application that allows a user to purchaser goods or services with his or her client device 119. Another example of a service provider service 136 could be a financial service application such as banking or brokerage application that allows a user to perform financial transactions (e.g., open a transaction account, line of credit, credit card account or brokerage account; send or receive a payment; pay down a balance on a line of credit or a credit card account; trade financial or equity instruments such as stocks, bonds, mutual funds, exchange traded funds, etc.).

The blockchain 116 can represent an immutable, append only, eventually consistent distributed data store formed from a plurality of nodes that maintain duplicate copies of data stored in the blockchain 116. The nodes of the blockchain 116 can use a variety of consensus protocols to coordinate the writing of data written to the blockchain. In order to store data to the blockchain 116, such as a record of a transaction of cryptocurrency coins or tokens between wallet addresses, users can pay cryptocurrency coins or tokens to one or more of the nodes of the blockchain 116. Examples of blockchains 116 include the BITCOIN network, the ETHEREUM network, the CARDANO network, the SOLANA network, the TEZOS network, etc.

In some implementations, smart contracts can be stored on the blockchain. A smart contract can represent executable computer code that can be executed by a node of the blockchain 116. In many implementations, the smart contract can expose one or more functions that can be called by any user or by a limited set of users. To execute one or more functions of a smart contract, an application can submit a request to a node of the blockchain to execute the function. The node can then execute the function and store the result to the blockchain 116. Nodes may charge fees in the form of cryptocurrency coins or tokens to execute a function and store the output, with more complicated or extensive functions requiring larger fees. An example of this implementation is the ETHEREUM blockchain, where users can pay fees, referred to as “gas,” in order to have a node of the ETHEREUM execute the function and store the result to the ETHEREUM blockchain. Additionally, the more “gas” a user pays, the more quickly the function will be executed and its results committed to the blockchain 116. Examples of the various smart contracts that can be stored on the blockchain 116 include the NFT smart contract 143.

The NFT smart contract 143 can be used to create new NFTs 146 and manage the ownership of previously created NFTs 146. Accordingly, the NFT smart contract 143 could include an NFT smart contract wallet address 149, and the functions provided by the NFT smart contract 143 could be executed to mint or create non-fungible tokens 146. Each NFT 146 can include an NFT identifier 153, which uniquely identifies an NFT 146 with respect to another NFT 146 issued by the NFT smart contract 143. Each NFT 146 can also include a status 156, which can represent the status or value of the characteristic of the owner of the NFT 146 (e.g., the user of the client device 119). Each NFT 146 can also include an owner wallet address 159, which can represent the wallet address of the current owner of the NFT 146.

The client device 119 is representative of a plurality of client devices that can be coupled to the network 123. The client device 119 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 119 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 119 or can be connected to the client device 119 through a wired or wireless connection.

The client device 119 can be configured to execute various applications such as a client application 163 or other applications. The client application 163 can be executed by a client device 119 to interact with the NFT smart contract 143, the evaluation service 126, and/or the service provider service 136. For instance, the client application 163 could have a blockchain client or wallet included as well as code for interacting with the service provide service 136. One example of such a client application 163 would be a web browser (e.g., GOOGLE CHROME, MOZILLA FIREFOX, or APPLE SAFARI) with a cryptocurrency wallet plugin (e.g., METAMASK, PHANTOM, TRUST WALLET, or similar browser extensions or plugins).

Various data can also be stored on the client device 119 for use with or by the client application 163. This could include one or more client key pairs 166, which could include a private key 169 and a public key 173, and personally identifying information (PII) 176. Examples of client key pairs 166 include any cryptographic key pair generated using a public key encryption algorithm (e.g., elliptic curve cryptography (ECC) algorithms, the Rivest Shamir and Adleman (RSA) algorithm, etc.). The wallet address of a user (e.g., for use as the owner wallet address 159) may be linked to, derived from, or associated with the client key pair 166 of a user. Examples of PII 176 include information such as the legal name of the user, the birthdate of the user, the contact information of the user (e.g., mailing address, email address, phone number(s), etc.), birthdate of the user, gender of the user, etc. This information could be cached or stored locally in one or more forms (e.g., as part of a user profile, as part of a user's contact card or information, etc.). In some instances, PII 176 could be inputted by a user into the client device 119 through a user interface in order to transmit the PII 176 to the evaluation service 126 (e.g., by entering a government identification number into the client application 163 using a keyboard or other apparatus).

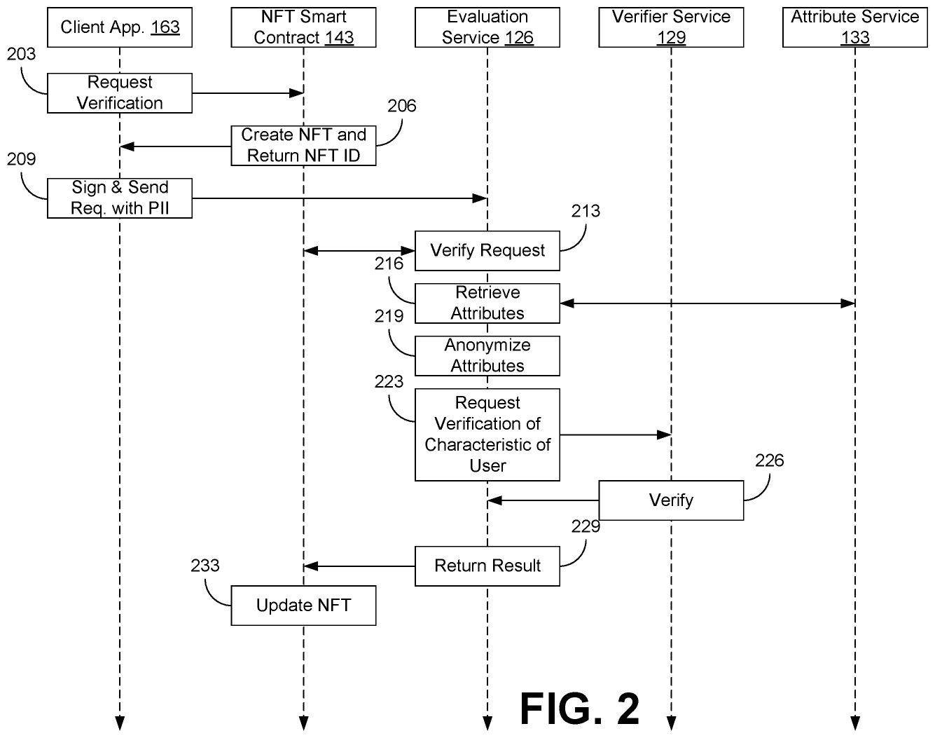

Referring next to FIG. 2, shown is a sequence diagram that provides one example of the interactions between the client application 163, the evaluation service 126, the verifier service 129, the attribute service 133, and the NFT smart contract 143. The sequence diagram of FIG. 2 provides merely an example of the many different types of interactions between the client application 163, the evaluation service 126, the verifier service 129, the attribute service 133, and the NFT smart contract 143. As an alternative, the sequence diagram of FIG. 2 can be viewed as depicting an example of elements of a method implemented within the network environment 100.

Beginning with block 203, the client application 163 could send a verification request to the NFT smart contract 143. The request for verification could be sent, for example, in order for a user of the client application 163 to interact with or obtain a service from the service provider service 136. For example, a user could request verification of their credit risk profile or creditworthiness in order to make a purchase with the service provider service 136 or open an account with the service provider service 136. The request for verification could include a transaction fee (e.g., ETHEREUM gas), a wallet identifier associated with the client application 163 (e.g., a wallet identifier derived from the public key 173), and potentially other information, such as the type of characteristic of the user of the client application 163 to be verified.

In some instances, the NFT smart contract 143 might only be able to verify one type of characteristic of the user of the client application 163 (e.g., a user's creditworthiness for a transaction). This could occur, for example, if an organization deployed an NFT smart contract 143 for a single purpose, such as determining the creditworthiness of the customer to make a purchase below a predefined threshold amount or the creditworthiness of the customer to make a single purchase. In these implementations, the type of characteristic of the user to be verified would be implied. However, a more general purpose NFT smart contract 143 could be deployed. In these implementations, the type of characteristic to be verified (e.g., identity, creditworthiness or credit risk, etc.) could be specified in the request made by the client application 163 to the NFT smart contract 143.

In response, at block 206, the NFT smart contract 143 could create an NFT 146, which would serve as a record of the request received from the client application 163. The owner wallet address 159 for the NFT 146 could be set to the wallet address associated with the request received at block 203. The NFT identifier 153 could then be returned to the client application 163, along with additional information such as a uniform resource locator (URL) or other identifier of the attribute service 133 to be used for verification of the characteristic of the user.

Next, at block 209, the client application 163 could send a signed request to the evaluation service 126. The signed request could be signed with the private key 169 on the client device 119 to prove that it was authorized by the owner of the client device 119. The request could also include the NFT identifier 153 that uniquely identifies the NFT 146 that represents the request, as well as PII 176 selected or approved by the user to be shared with the evaluation service 126. The request could also include the URL or other identifier of the attribute service 133 to be used.

Moving on to block 213, the evaluation service 126 could verify the signed request received from the client application 163. For example, the evaluation service 126 could determine if there is an NFT 146 with an owner wallet address 159 that matches the wallet address associated with or derived from the public key 173 stored on the client device 119. If such an NFT 146 does not exist, then the request is invalid. If such an NFT 146 does exist, then the evaluation service 126 could use said public key 173 to verify the signature of the signed request to confirm its authenticity. If the signature is invalid, then the evaluation service 126 could determine that the request is invalid. If the request is invalid, then the process could be terminated by the evaluation service 126. However, if the request is valid, then the evaluation service 126 could continue to block 219.

After verifying the signed request, the evaluation service 126 could, at block 216, retrieve one or more attributes from the attribute service 133. For example, the evaluation service 126 could send a request that includes one or more components of the PII 176 received at block 209. For example, the evaluation service 126 could include the legal name, date of birth, and government identifier (e.g., social security number) of the user of the client device 119 or client application 163 in the request to a credit bureau. The credit bureau could then retrieve the credit report or financial information related to the individual with a matching legal name, date of birth, and government identifier and return said credit report or financial information to the evaluation service 126.

Proceeding to block 219, the evaluation service 126 could anonymize the attributes returned by the attribute service 133. For example, the evaluation service could use regular expressions or similar filters to search for and replace references to the name of the user, date of birth of the user, government identifier of the user, gender or sex of the user, etc. As another example, the evaluation service 126 could use a trained machine-learning model to evaluate the data returned by the attribute service 133 to recognize PII 176 contained in the attributes. The evaluation service 126 could then remove or redact the PII 176 identified by the machine-learning model.

Then, at block 223, the evaluation service 126 could send a request to the verifier service 129 to verify the characteristic of the user of the client application 163 or client device 119. The request could include the anonymized attributes generated at block 219. The request could also specify a prompt to be used, which could be in a structured form (e.g., a request or query with a predefined schema and/or parameters) or in an unstructured form (e.g., free form or unstructured text). Examples of prompts that could be provided by the evaluation service 126 to the verifier service 129 include the following (or variations thereof):

“Is the user approved to make a purchase
based on the included attributes?”
“Is the user approved to obtain a service
based on the included attributes?”
“Is the user approved to make a purchase
below a threshold of $XYZ based
on the included attributes?”
“Is the user approved to open a checking
account based on the included attributes?”
“Is the user approved to open a line of credit
based on the included attributes?”
“Is the user approved to open a credit card
account based on the included attributes?”
“Is the user approved to open a transaction
account based on the included attributes?”
“Is the user approved for a mortgage up to $XYZ
based on the included attributes?”
“Is the user a high credit risk based on the included attributes?”
“Is the user a low credit risk based on the included attributes?”

In response, at block 226, the verifier service 129 could verify the characteristic based at least in part on the prompt and the included attributes. For example, the verifier service 129 could use the large language model 139 to interpret the prompt and generate an answer to the prompt based at least in part on the included anonymized attributes. The verifier service 129 could then return the result generated using the large language model 139 to the evaluation service 126. Because the attributes have been anonymized, the decision can be made without disclosing any personally identifiable information about the user to the verifier service 129. This allows, for example, for credit decisions to be made anonymously and, therefore, equitably and fairly.

At block 229, the evaluation service 126 can similarly return the result received from the verifier service 129 to the NFT smart contract 143. For example, the evaluation service 126 could include the NFT identifier 153 and the result received from the verifier service 129 in the response returned to the NFT smart contract 143.

Proceeding to block 233, the NFT smart contract 143 can update the NFT 146 matching the NFT identifier 153 based on the result returned by the evaluation service 126. For example, if the evaluation service 126 returns a result indicating that the characteristic of the user has been verified (e.g., that the user is credit worthy, that the user is approved to make a particular purchase, open a specified account, etc.), then the NFT smart contract 143 could update the status 156 of the NFT 146 to reflect that the characteristic has been verified. Similarly, if the evaluation service 126 returns a result indicating that the characteristic of the user has not been verified (e.g., that the user is a high credit risk, that the user is not approved to make a particular purchase, open a specified account, etc.), then the status 156 of the NFT 146 could be updated to reflect that the user is not approved.

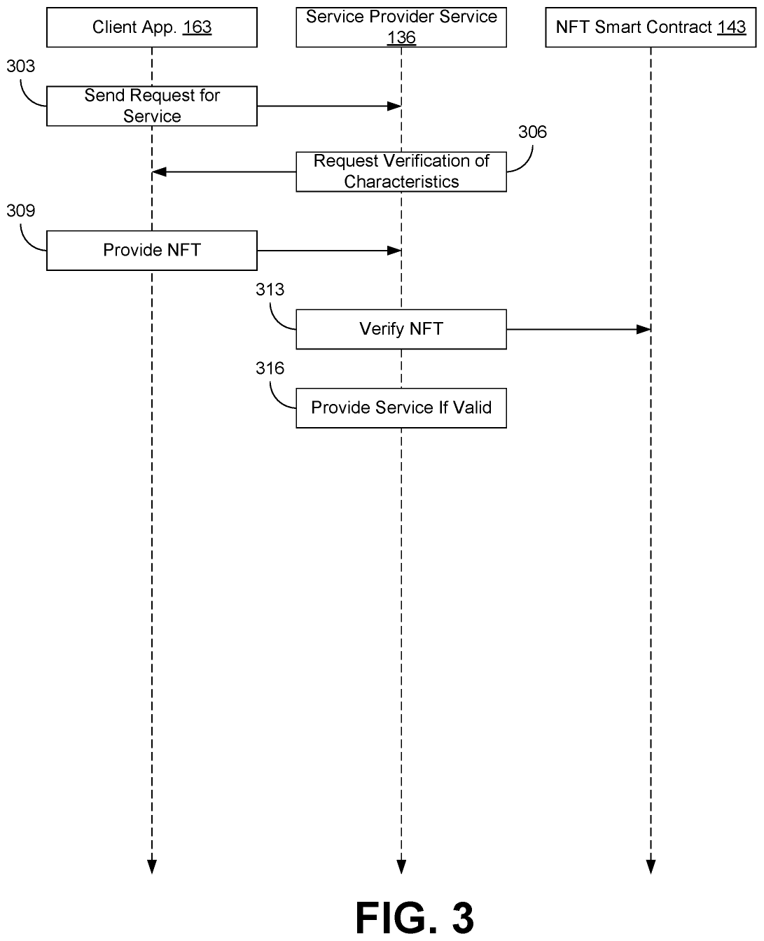

Referring next to FIG. 3, shown is a sequence diagram that provides one example of the interactions between the client application 163, the service provider service 136, and the NFT smart contract 143. The sequence diagram of FIG. 3 provides merely an example of the many different types of interactions between the client application 163, the service provider service 136, and the NFT smart contract 143. As an alternative, the sequence diagram of FIG. 3 can be viewed as depicting an example of elements of a method implemented within the network environment 100.

Beginning with block 303, the client application 163 can send a request to the service provider service 136. The request could be to purchase or perform a service on behalf of the user of the client application 163. Such a request could be made, for example, to make a purchase through an electronic commerce shopping platform, to open an account with a financial institution, to request a loan from a financial institution, etc.

Then, at block 306, the service provider service 136 could send a response to the client application 163 requesting verification of one or more characteristics. For example, the service provider service 136 could specify a request that the user has credit approval to make a purchase, or make a purchase up to or below a certain threshold, has credit approval to open an account, etc.

Next, at block 309, the client application 163 can provide an NFT identifier 153 for an NFT 146 in response, the NFT 146 representing that the user has the appropriate characteristics to receive the service (e.g., the user has a sufficient credit worthiness or risk profile). To prove ownership of the NFT 146, the client application 163 could sign the NFT identifier 153 with the private key 169 corresponding to the current owner wallet address 159 of the NFT 146.

In some implementations, the NFT 146 could be preexisting (e.g., the user has already had the characteristic verified). In other implementations, the NFT 146 could be created in response to the request from the service provider service 136 sent at block 306. In these implementations, the prompt to be used could be included in the request made by the service provider 136 at block 306.

Proceeding to block 313, the service provider service 136 can verify the NFT 146 that was presented by the client application 163 at block 309. For example, the service provider service 136 can make a call to the NFT smart contract 143 to determine whether an NFT 146 matching the NFT identifier 153 provided at block 309 exists. If the NFT 146 exists, then the service provider service 136 could verify the signature provided at block 309 to confirm that the user of the client application 163 is the owner of the NFT 146. If the NFT 146 is valid and the signature is verified, then the service provider service 136 can evaluate status 156 of the NFT 146 to determine if the user has the appropriate characteristic (e.g., risk profile, credit worthiness, etc.).

If the user has the appropriate characteristic, then the service provider service 136 can provide the requested service at block 316 (e.g., complete the purchase, proceed with opening the account, etc.). However, if the user lacks the appropriate characteristic (e.g., the status 156 indicates that the user has an unsatisfactory credit profile), then the process could end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive a first request from a client device to verify a characteristic of a user associated with the client device, the request identifying an attribute service and the request comprising personally identifying information (PII) associated with the user of the client device;
send a second request for one or more attributes of the user to the attribute service, wherein the second request comprises at least a portion of the PII associated with the user of the client device;
receive the one or more attributes of the user from the attribute service;
anonymize the one or more attributes of the user to generate one or more anonymized attributes; and
send the one or more anonymized attributes and a prompt to a verifier service, wherein the prompt causes a large language model associated with the verifier service to verify the characteristic of the user based at least in part on the one or more anonymized attributes.

2. The system of claim 1, wherein the machine-readable instructions further cause the computing device to at least verify the first request with a smart contract.

3. The system of claim 1, wherein the machine-readable instructions further cause the computing device to at least verify a signature of the first request.

4. The system of claim 1, wherein the machine-readable instructions that cause the computing device to anonymize the one or more attributes of the user to generate one or more anonymized attributes, when executed by the processor, further cause the computing device to
apply a machine learning model to the one or more attributes to identify personally identifying information within the one or more attributes; and
remove the personally identifying information from the one or more attributes.

5. The system of claim 1, wherein the machine-readable instructions further cause the computing device
receive, from the verifier service, a verification of the characteristic; and
return the verification of the characteristic to a smart contract.

6. The system of claim 1, wherein the machine-readable instructions are executed within a trusted execution environment provided by the processor of the computing device.

7. The system of claim 1, wherein the verification of the characteristic is represented by the smart contract as a non-fungible token (NFT) on a blockchain.

8. A method performed by a computing device, comprising:
receiving a first request from a client device to verify a characteristic of a user associated with the client device, the request identifying an attribute service and the request comprising personally identifying information (PII) associated with the user of the client device;
sending a second request for one or more attributes of the user to the attribute service, wherein the second request comprises at least a portion of the PII associated with the user of the client device;
receiving the one or more attributes of the user from the attribute service;
anonymizing the one or more attributes of the user to generate one or more anonymized attributes;
sending the one or more anonymized attributes and a prompt to a verifier service, wherein the prompt causes a large language model associated with the verifier service to verify the characteristic of the user based at least in part on the one or more anonymized attributes;
receiving, from the verifier service, a verification of the characteristic; and
returning the verification of the characteristic to a smart contract.

9. The method of claim 8, further comprising verifying the first request with the smart contract.

10. The method of claim 8, further comprising verifying a signature of the first request.

11. The method of claim 8, wherein anonymizing the one or more attributes of the user to generate one or more anonymized attributes further comprises:
applying a machine learning model to the one or more attributes to identify personally identifying information within the one or more attributes; and
removing the personally identifying information from the one or more attributes

12. The method of claim 8, further comprising:
receiving, from the verifier service, a verification of the characteristic; and
returning the verification of the characteristic to a smart contract.

13. The method of claim 8, wherein the method is performed within a trusted execution environment provided by a processor of the computing device.

14. The method of claim 8, wherein the verification of the characteristic is represented by the smart contract as a non-fungible token (NFT) on a blockchain.

15. A non-transitory, computer-readable medium, comprising machine-readable instructions that, when executed by a processor of a computing device, cause the computing device to at least:
receive a first request from a client device to verify a characteristic of a user associated with the client device, the request identifying an attribute service and the request comprising personally identifying information (PII) associated with the user of the client device;
send a second request for one or more attributes of the user to the attribute service, wherein the second request comprises at least a portion of the PII associated with the user of the client device;
receive the one or more attributes of the user from the attribute service;
anonymize the one or more attributes of the user to generate one or more anonymized attributes;
send the one or more anonymized attributes and a prompt to a verifier service, wherein the prompt causes a large language model associated with the verifier service to verify the characteristic of the user based at least in part on the one or more anonymized attributes;
receive, from the verifier service, a verification of the characteristic; and
return the verification of the characteristic to a smart contract.

16. The non-transitory, computer-readable medium of claim 15, wherein the machine-readable instructions further cause the computing device to at least verify the first request with the smart contract.

17. The non-transitory, computer-readable medium of claim 15, wherein the machine-readable instructions further cause the computing device to at least verify a signature of the first request.

18. The non-transitory, computer-readable medium of claim 15 wherein the machine-readable instructions that cause the computing device to anonymize the one or more attributes of the user to generate one or more anonymized attributes, when executed by the processor, further cause the computing device to
apply a machine learning model to the one or more attributes to identify personally identifying information within the one or more attributes; and
remove the personally identifying information from the one or more attributes.

19. The non-transitory, computer-readable medium of claim 15, wherein the machine-readable instructions further cause the computing device
receive, from the verifier service, a verification of the characteristic; and
return the verification of the characteristic to a smart contract.

20. The non-transitory, computer-readable medium of claim 15, wherein the machine-readable instructions are executed within a trusted execution environment provided by the processor of the computing device.
